(19) United States
(12) Patent Application Publication
(10) Pub. No.: US 2011/0264531 A1
(43) Pub. Date: Oct. 27, 2011

(54) WATCHING A USER'S ONLINE WORLD

(75) Inventors: Tarun Bhatia, Burbank, CA (US); Eric Theodore Bax, Pasadena, CA (US)

(73) Assignee: Yahoo! Inc., Sunnyvale, CA (US)

(21) Appl. No.: 12/767,246

(22) Filed: Apr. 26, 2010

(51) Int. Cl. G06F 15/173; G06Q 30/00; G06F 15/16; G06F 17/30

(52) U.S. Cl. 705/14.66; 709/224; 709/204; 707/802; 707/E17.044

(57) ABSTRACT

The present invention provides methods and systems for use in assessing sentiment of users associated with one or more Web-based activities or communications of a user, which can include messaging associated with one or more social networking applications. Furthermore, information or services are provided to the user, or another user, in connection with the assessed sentiment. For example, a user may be alerted, or action may be taken, if unforeseen or negative sentiment reaches or exceeds a designated threshold.

### BACKGROUND

With the proliferation of disparate platforms and applications, including Web-based applications and social networking applications, a user's online “world” has become increasingly complex, fragmented, and difficult to manage.

For instance, the advent of open social platforms and applications has led to much greater expressivity of online users. However, a user's expressivity through open social platforms can sometimes lead to negative or unforeseen sentiments from other users, which can be troublesome and difficult to manage.

Furthermore, increasingly, an online user may leverage many diverse applications, including Web-based applications, in connection with a particular task, topic, or focus of activity. Use of and interaction on various different applications may leave many user footprints in connection with a particular task. However, access to information relating to a particular task, such as comprehensive information across many applications, can be challenging.

There is a need for techniques for use in managing and providing services in connection with a user's online world.

### SUMMARY

Some embodiments of the invention provide methods and systems for use in searching a user's online world, across independently provided applications including Web-based and desktop applications. Some embodiments allow a user to comprehensively gather information related to a particular task, topic, etc., from various elements of the user's online world. In some embodiments, information is collected and indexed relating to activities and communications of a user, and of other users in association (whether direct or indirect) with activities and communications of the user. Some embodiments include real-time monitoring and collection of information relating to activities of the user.

Activity information, which can include user messaging, documents, etc., may be collected across different or disparate devices, platforms, and applications, which can include independently operational Web-based applications, which can include Web sites, provided by different, independent providers. In some embodiments, activity information is also collected in association with desktop applications.

A graphical user interface may be provided to allow user searching in association with the collected and indexed information. Search results may be provided using a graphical user interface that can include, for example, Web results, personal results, and desktop results. In some embodiments, the search results or other aspects may be customized by the user.

In some embodiments, Web-based applications broadly include Web sites and Web pages. For instance, some embodiments include collection of information from various types of Web sites. Such Web sites, or portions thereof, can be considered part of the user's world, and later can be searched by the user. For example, various Web sites or pages, including social networking sites, blogging sites, review sites, etc., or portions thereof, may be part of the user's world. For instance, if the user posts a blog, review, or comment on a Web page of a Web site, that page, or a portion thereof, and potentially other portions of the associated Web site, may be considered part of the user's world. For example, in some embodiments, a page, pages, linked pages, portions of a page or pages, etc. may be captured and considered part of the user's world. Later, the user may perform a search that can include searching such information.

In some embodiments, information other than information reflecting activity or communications of the user may also be collected as part of the user's world. This could include, for example, other users' comments in response to, or otherwise associated with, a comment of the user, or still other users' comments in response to those users' comments, etc. Some such information may be tracked via logins, but some may not require logins.

Furthermore, in some embodiments, information other than information associated, directly, or indirectly, with activities or communications of the user can none the less be considered part of the user's online world, and can be collected and made searchable. This can include, for example, information associated with activities and communications of other users who may be associated with or important to the user, such as the user's immediate family, extended family, friends, users in the user's social groups or community, etc. In some embodiments, information collected as part of the user's world can be defined or bounded in different ways, with different degrees and types of breadth. In some embodiments, such coverage may be definable, configurable or partially configurable by the user.

In some embodiments, the user's world can be defined to include worlds of, or portions of worlds of, other users, or groups of users, such as users that may be associated with or of importance to the user. For example, such other users may be defined to include the user's immediate family, the user's extended family, friends of the user, social groups of the user, communities of the user, etc., or combinations thereof. Including worlds of or portions of worlds of, such other users or user groups as part of the user's searchable world may be particularly desirable if, for instance, the world of the user is limited or the user otherwise desires an expanded searchable world.

Some embodiments of the invention provide methods and systems for use in what can be viewed in some ways as “watching” over a user's online world. Some embodiments include monitoring and assessing sentiment of users associated with one or more Web-based activities or communications of a user. Activities and communications can include messaging of the user and other users, such as through one or more social networking applications. Furthermore, information or services are provided to the user in connection with the assessed sentiment. For example, some embodiments include assessing sentiment of other users or a group of other users, such as emotional sentiment, perception or opinion, in reaction to one or more activities or communications of the user. Some embodiments include monitoring activities or communications of particular users or groups of users, such as family or friends of the user, users in social groups or communities of the user or of particular importance to the user, etc. Reporting, including a rating or measure of this sentiment, may be provided to the user. Ratings may be based in part on weighting or other input provided from the user. Furthermore, a user may be alerted, or action may be taken, such as pulling down, deleting or disabling certain messages, etc., if, for example, unforeseen or negative sentiment reaches or exceeds a designated threshold.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a flow diagram illustrating a method according to one embodiment of the invention;

FIG. 6 is a block diagram illustrating one embodiment of the invention;

FIG. 7 is a block diagram illustrating one embodiment of the invention;

FIG. 8 is a graphical user interface illustrating one embodiment of the invention;

FIG. 9 is a block diagram illustrating one embodiment of the invention; and

FIG. 10 is a flow diagram illustrating one embodiment of the invention.

While the invention is described with reference to the above drawings, the drawings are intended to be illustrative, and the invention contemplates other embodiments within the spirit of the invention.

### DETAILED DESCRIPTION

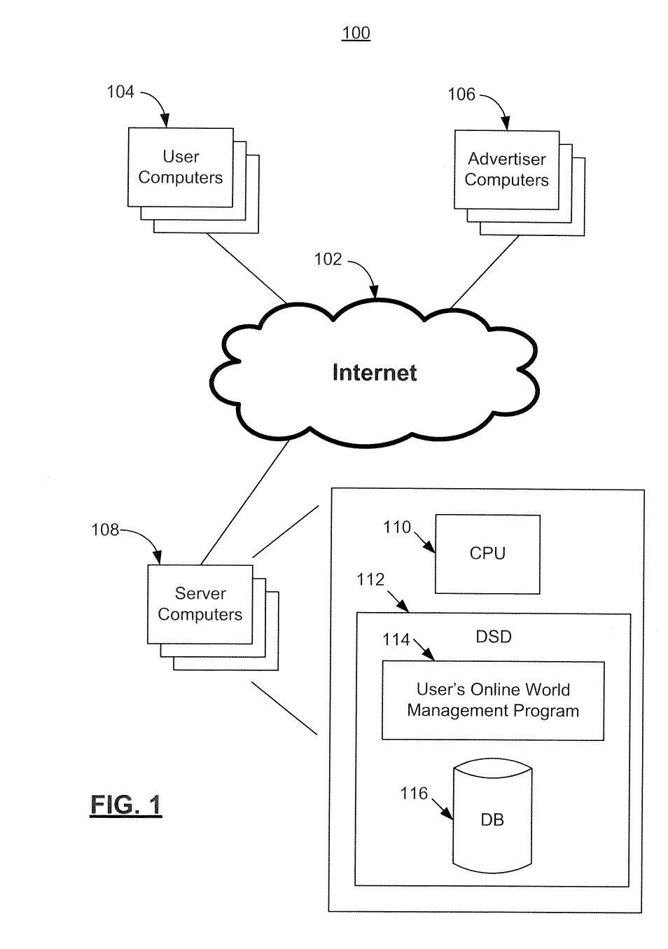

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a User's Online World Management Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

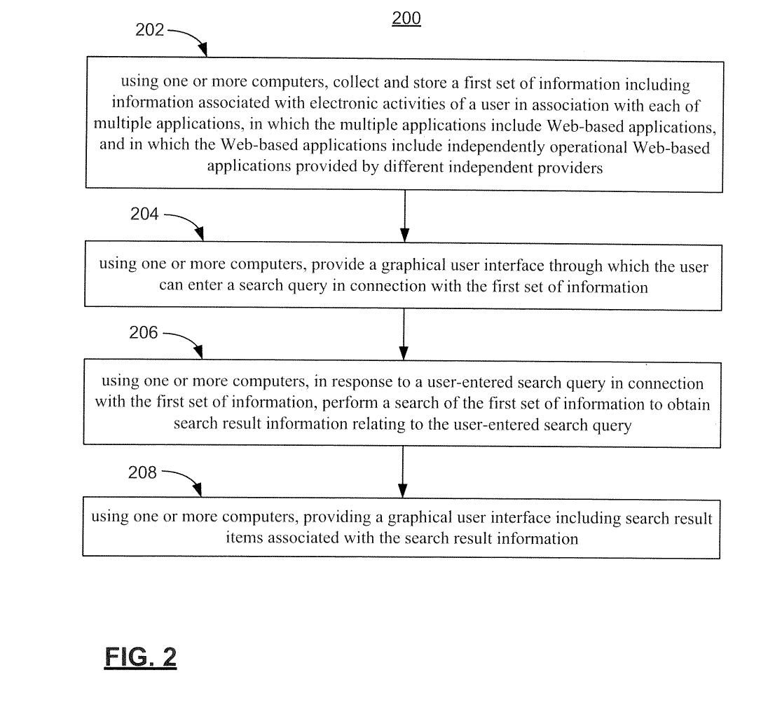

FIG. 2 is a flow diagram of a method 200 according to one embodiment of the invention. At step 202, using one or more computers, a first set of information is collected and stored, including information associated with electronic activities of a user in association with each of multiple applications. The multiple applications include Web-based applications, including independently operational Web-based applications provided by different independent providers.

At step 204, using one or more computers, a graphical user interface is provided, through which the user can enter a search query in connection with the first set of information.

At step 206, using one or more computers, in response to a user-entered search query in connection with the first set of information, a search is performed of the first set of information to obtain search result information relating to the user-entered search query.

At step 208, using one or more computers, a graphical user interface is provided, including search result items associated with the search result information.

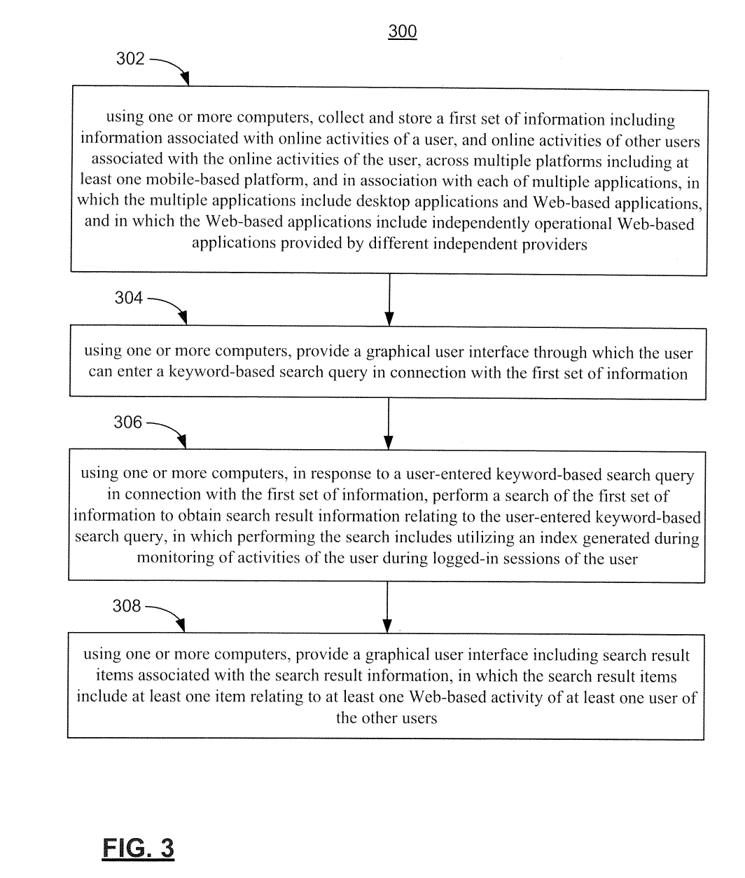

FIG. 3 is a flow diagram illustrating a method 300 according to one embodiment of the invention. At step 302, using one or more computers, a first set of information is collected and stored, including information associated with online activities of a user, and online activities of other users associated with the online activities of the user. Such activity of other users can be of various degrees of separation. For example, if a first other user comments on a post by the user, and a second other user blogs about that post, and a third other user posts a blog in response to the second other user's blog, some or all of this activity and communications can be included in the first set of information. Furthermore, in some embodiments, the number of levels of separation (such as friends, friends of friends, etc.) can be customized, limited, or otherwise controlled in whole or in part by the user.

Information is collected in association with activities across multiple platforms including at least one mobile-based platform, and in association with each of multiple applications, in which the multiple applications include desktop applications and Web-based applications. The Web-based applications include independently operational Web-based applications provided by different independent providers.

At step 304, using one or more computers, a graphical user interface is provided through which the user can enter a keyword-based search query in connection with the first set of information.

At step 306, using one or more computers, in response to a user-entered keyword-based search query in connection with the first set of information, a search is performed of the first set of information to obtain search result information relating to the user-entered keyword-based search query. Performing the search includes utilizing an index generated during monitoring of activities of the user during logged-in sessions of the user.

At step 308, using one or more computers, a graphical user interface is provided including search result items associated with the search result information, in which the search result items include at least one item relating to at least one Web-based activity of at least one user of the other users.

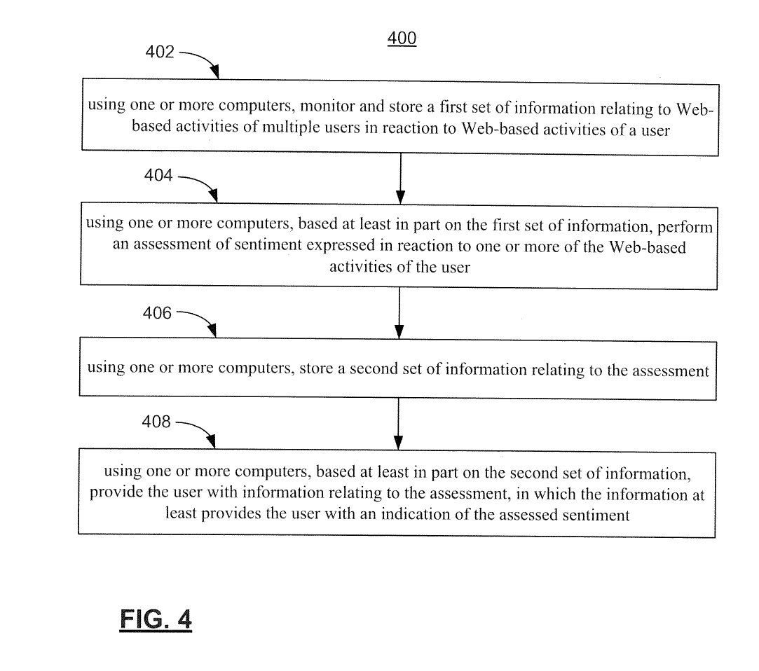

FIG. 4 is a flow diagram illustrating a method 400 according to one embodiment of the invention. At step 402, using one or more computers, a first set of information is monitored and stored, relating to Web-based activities of multiple users in reaction to Web-based activities of a user.

At step 404, using one or more computers, based at least in part on the first set of information, an assessment is performed of sentiment expressed in reaction to one or more of the Web-based activities of the user.

At step 406, using one or more computers, a second set of information is stored, relating to the assessment.

At step 408, using one or more computers, based at least in part on the second set of information, the user is provided with information relating to the assessment, in which the information at least provides the user with an indication of the assessed sentiment.

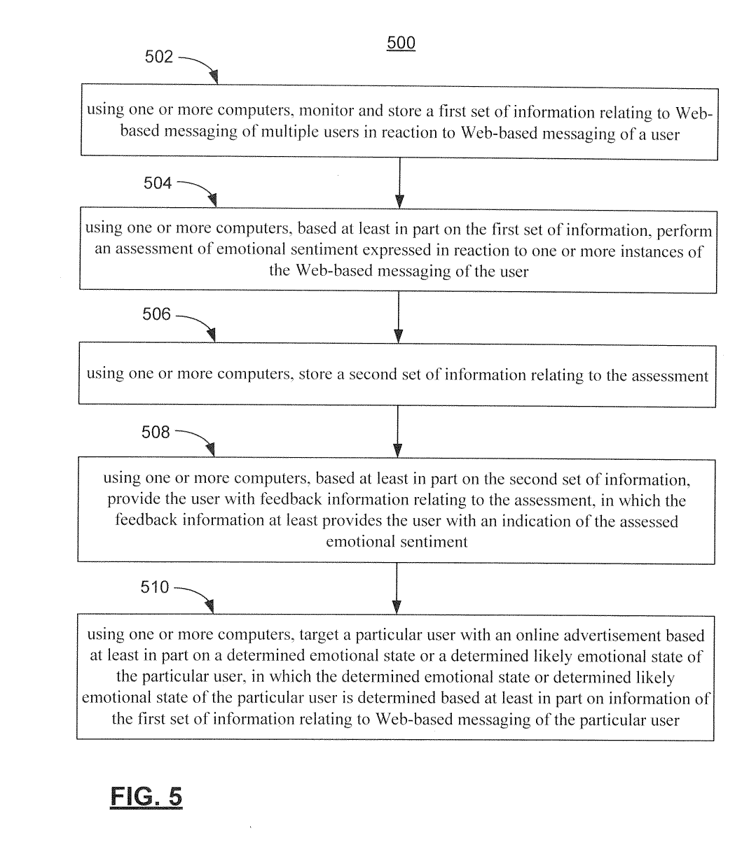

FIG. 5 is a flow diagram illustrating a method 500 according to one embodiment of the invention. At step 502, using one or more computers, a first set of information is monitored and stored relating to Web-based messaging of multiple users in reaction to Web-based messaging of a user.

At step 504, using one or more computers, based at least in part on the first set of information, an assessment is performed of emotional sentiment expressed in reaction to one or more instances of the Web-based messaging of the user.

At step 506, using one or more computers, a second set of information is stored relating to the assessment.

At step 508, using one or more computers, based at least in part on the second set of information, the user is provided with feedback information relating to the assessment. The feedback information at least provides the user with an indication of the assessed emotional sentiment.

At step 510, using one or more computers, a particular user is targeted with an online advertisement based at least in part on a determined emotional state or a determined likely emotional state of the particular user. The determined emotional state or determined likely emotional state of the particular user is determined based at least in part on information of the first set of information relating to Web-based messaging of the particular user.

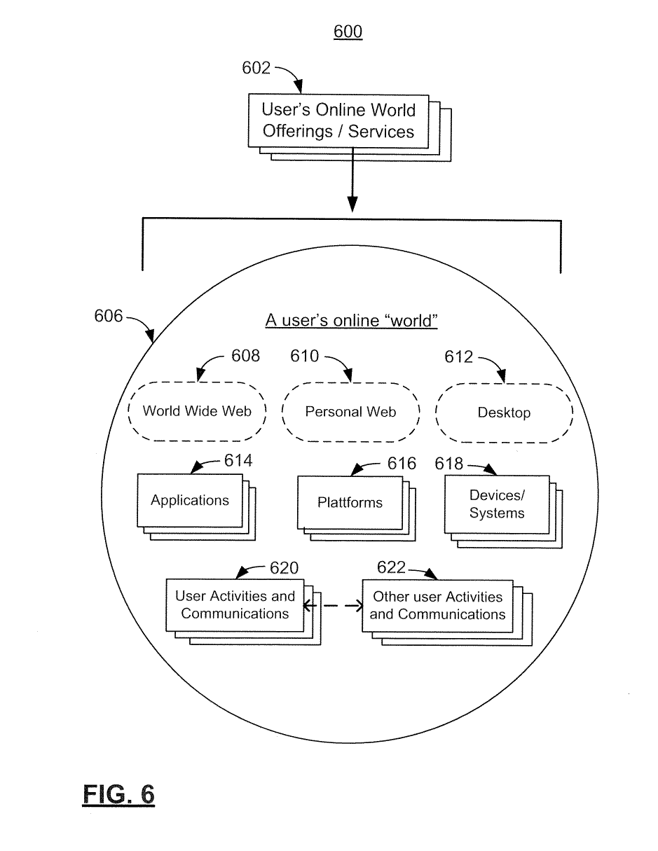

FIG. 6 is a block diagram 600 illustrating one embodiment of the invention. Circle 606 represents a user's online world. Elements or aspects of the user's online world are depicted inside the circle 606, and are intended to be exemplary and non-limiting.

As depicted, the user's online world can be viewed as having elements including World Wide Web elements 608, personal Web elements 610 and desktop elements 612. A user's online world can span use of various applications 614, platforms 616, and devices or systems 618. A user's online world can include activities and communications 620 of the user, and can also include activities and communications of other users 622. The activities and communications of other users 622 can include activities and communications of other users that are associated with the user or with activities or communications of the user, such as messaging with the user, sentiment expressed about the user or activities or communications of the user, etc.

Block 602 represents any of various offerings or services that may be provided in some embodiments of the invention, including search-related services, sentiment assessment, reporting and management services, and other services.

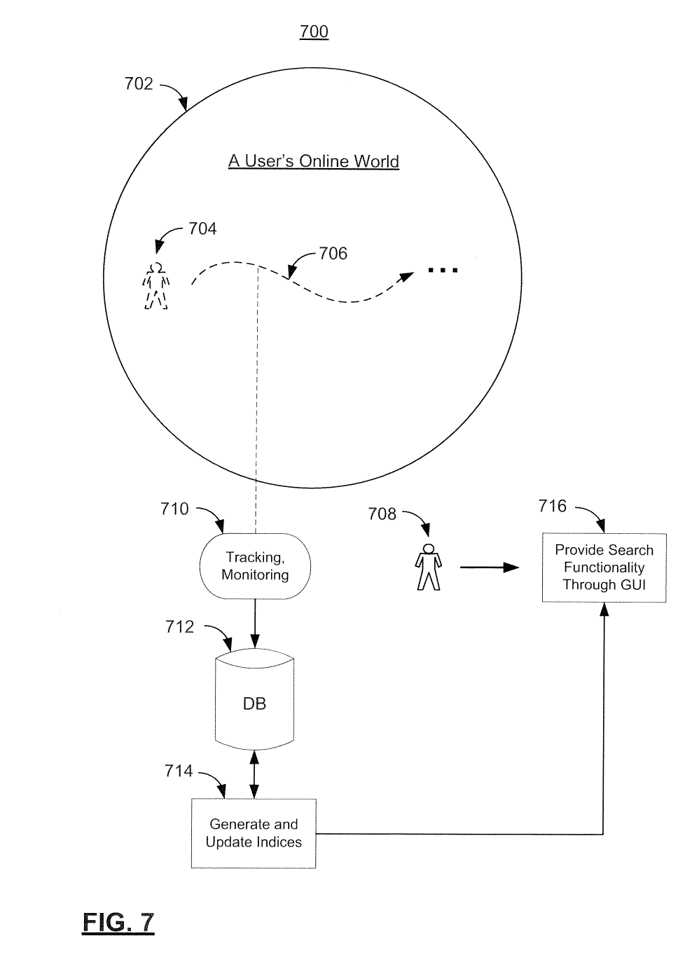

FIG. 7 is a block diagram 700 illustrating one embodiment of the invention. A user's online world is depicted by circle 702. In some embodiments, a user's activities and communications in, and as part of, the user's online world can be viewed as an ongoing journey of the user through the user's ever-expanding and evolving online world. This journey, or series of activities and communications, is represented by curve 706. The user's virtual presence or identity in this journey is represented by FIG. 704.

As depicted, in some embodiments, monitoring and tracking 710 is performed of activities and communications of the user, which can be viewed as monitoring the user's ongoing journey 706 in the user's online world 702. In some embodiments, a user may be authenticated and logged in, voluntarily allowing accurate tracking. Tracked information is stored in one or more databases, such as database 712. The stored information can be used in providing various offerings or services according to embodiments of the invention, including search-related services as well as sentiment assessment, reporting, and management services, as described in detail herein.

At step 714, indices are generated using the information stored in the database 712.

At step 716, search functionality is provided to the user 708 through one or more graphical user interfaces or displays, in connection with the user's online world 702.

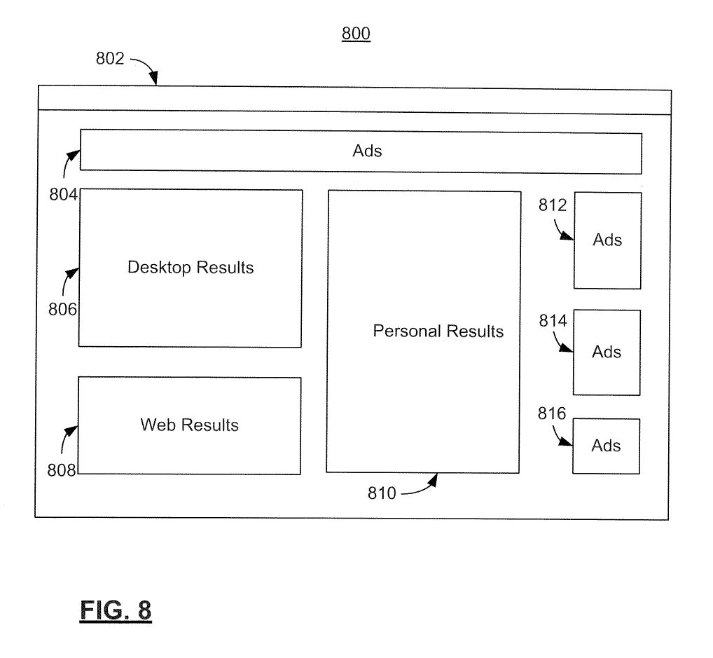

FIG. 8 is a graphical user interface (GUI) 800 illustrating one embodiment of the invention. The GUI 800 may be displayed, for example, in response to a keyword-based search query entered by a user in connection with the user's online world.

The GUI 800 may be divided into various sections. In some embodiments, these sections may be defined using input from the user, and the GUI itself may also be customizable by the user, such as by customizing the size and content of particular elements of the display, or associated functionality.

As depicted, the GUI 800 is divided into result sections including desktop results 806, Web results 808, and personal results 810. Desktop results can include results relating to use of desktop applications, including documents, presentations, etc. Web results can include Web page links, etc. Personal results can include items considered to be personal in nature, such as various messaging, chat, photos, etc.

The GUI 800 may include functionality, including links, other selectable and functional result items, etc. In some embodiments, the GUI 800 may provide comprehensive, integrated, organized access to collected, various disparate components of the user's online world that relate to a particular topic, task, etc., which the user might otherwise have much difficulty in remembering the precise location of, or accessing in a convenient or complete fashion.

Additionally, online advertisements may be provided as part of the GUI 800, such as those depicted by blocks 804, 812, 814 and 816. The advertisements may be targeted in many ways, including targeting based on factors including the search, search results, and any of various information available regarding the user's online world, as may be collected in embodiments of the invention. Furthermore, in embodiments of the invention including sentiment assessment, reporting, and management services, sentiment-associated factors may also be used in targeting, such as emotional targeting.

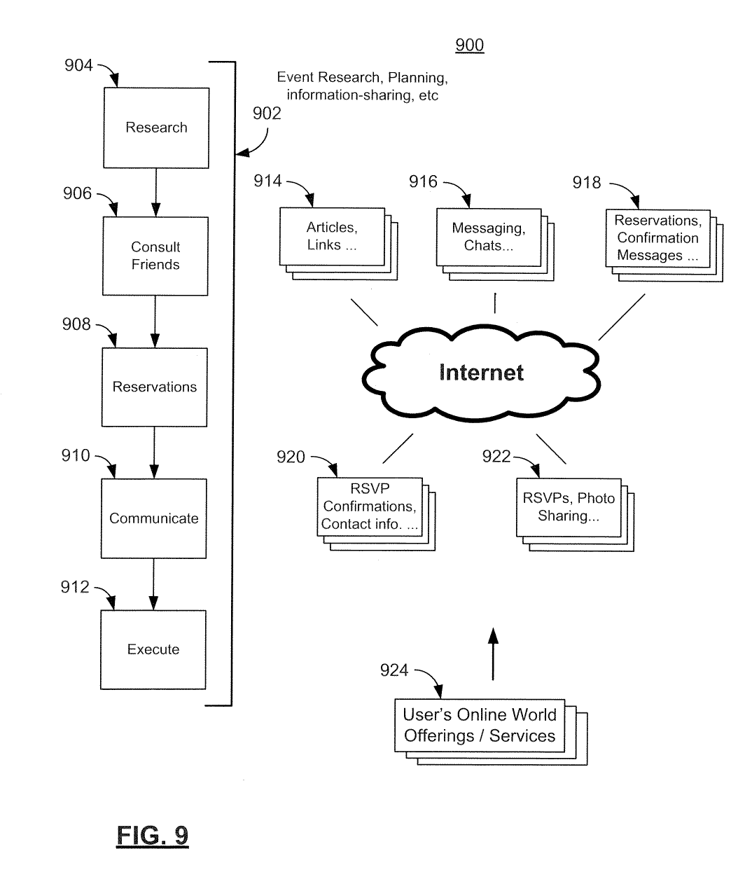

FIG. 9 is a block diagram 900 illustrating one embodiment of the invention. Particularly, FIG. 9 depicts an example of a many-faceted task in a user's online world, in connection with which services or offerings 924 according to embodiments of the invention may be utilized. Such services or offerings can broadly include providing functionality, applications, information, etc. utilizing collected information relating to the user's online world.

Specifically, FIG. 9 depicts elements 902 of researching, planning, and sharing information regarding a particular event, such as a vacation, meeting, etc. For example, depicted elements include research 904, consulting friends 906, making reservations 908, various communications 910, and elements of execution 912 of tasks or sub-tasks relating to the event.

The various elements 904-912 can lead to numerous disparate online activities and communications, such as, as just a few examples, articles, links, etc. 914, messaging, chats, etc. 916, reservations, confirmation messages, etc. 918, RSVP confirmations, contact information, etc. 920, and RSVPs, photo-sharing, etc. 922.

Some embodiments of the invention include tracking and collection of information regarding the various elements of researching, planning, and sharing of information regarding the event, including various online activities and communications, such as those depicted by blocks 904-912. Furthermore, in some embodiments, the user can perform a search related to the event, and obtain results spanning various activities and communications, applications, platforms, devices, etc.

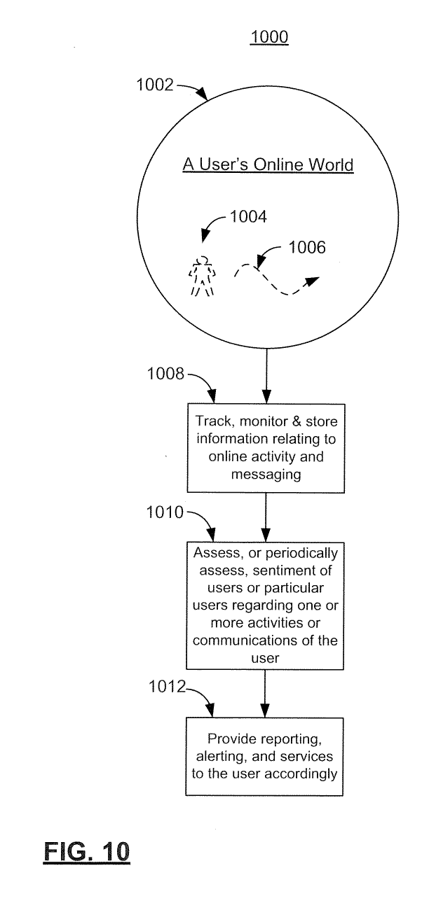

FIG. 10 is a flow diagram 1000 illustrating one embodiment of the invention. Particularly, FIG. 10 relates to sentiment assessment, reporting, and associated management. Sentiment can include, for example, emotional sentiment, perceptions, or opinions relating to the user or elements of the user's online world, such as particular activities, messaging, or online creations of the user, for example.

Curve 1006 represents activities and communications of the user, whose online presence is represented by figure 1004, in the user's journey through, and as part of, the user's online world 1002.

Step 1008 represents tracking, monitoring and storing of information relating to activities and communications of the user, and of associated or relevant activities and communications of other users, such as conversations with the user or other users, etc.

Step 1010 represents assessment, which may include periodic and updated assessment, of sentiment of users or a particular group of users regarding one or more activities or communications of the user.

Step 1012 represents providing reporting, alerting, and other services to the user in association with the sentiment assessment. For example, in some embodiments, alerts may be utilized, such as user-customizable alerts. For example, a user may be alerted and provided with reporting if negative or unexpected sentiment reaches or surpasses a certain threshold. Furthermore, in some embodiments, services may be provided to the user, such as, for example, deletion of communications, such as postings or blogs, which may have generated unwanted sentiment.

Some embodiments of the invention provide techniques for use in searching in connection with a user's online world. In some embodiments, methods and systems are provided for aggregating deep, or difficult to identify or gather, search results, relating to a user's online world, which can include search results across Web applications offered by independent providers. Some embodiments are enhanced by, or especially valuable in connection with, logged-in user sessions. In some embodiments, documents or other items associated with a user, or the user's activities and communications online, are associated with the user's profile.

In some embodiments, after information is collected, stored, and indexed, search functionality is provided to the user. The user can enter a search query, causing a search to be performed, in which documents or other items are retrieved across the many applications or other elements of the user's online world that are linked to the user or the user's profile.

Some embodiments of the invention include a recognition that the advent of open platforms and proliferation of applications means that a user may leverage numerous applications from different providers to achieve a certain task over a period of time. Each application interaction can leave a user footprint that is trapped within, but related to a common theme or task of the user. It can be problematic to access all this information, such as by logging onto the various applications separately. Furthermore, the user may well not remember exactly where the relevant information remains trapped.

Additionally, search can play a critical role in pulling together a user's online world, and increasingly so as the online aspect of people's lives gets fragmented across applications, such as, for example, Facebook, Twitter, LinkedIn, iPhone applications, and many more current and to be introduced. Some embodiments of the invention provide a search service that pulls up all of these documents and items from within disparate applications, subject to user authentication, and presents them in a single results page, grouped logically.

As an example of a situation for which searching according to embodiments of the invention could be useful, consider the following example. Suppose that Amy is planning an outing to the Hollywood Bowl. She sends emails to her friends through Yahoo! mail. A friend of Amy's receives the email and mentions it to other common friends on Facebook. One such person reaches out to Amy on Facebook and offers to help plan. This person also reaches out frequently to Amy on Yahoo! Messenger, an instant messaging application. It is very easy to understand that over the course of the next few days, a lot of messages and communications could be generated on this topic across applications such as Twitter, Facebook, Messenger, Yahoo! email, etc. In some embodiments of the invention, Amy would be able to retrieve a contact number, an RSVP, etc., regardless of which application was used in generating or sharing the message.

Some embodiments of the invention include tracking and providing search results that include information stored in desktop applications, which can include, for example, email, documents, brochures, presentations, pictures, videos, rich media, music playlists, etc.

In some embodiments, to facilitate searching, an index is generated that can access a user's, such as Amy's, documents within various applications. In some embodiments, this can be a personalized index, with relevance scores that are tuned for or by Amy. Amy's online world could be indexed without constraining the results to the confines of a single application. This can create a much richer and more relevant search experience, and provide a compelling reason to come to and use the service provider. In particular, the compelling search experience could incentivize users to log in, allowing authentication and tracking across applications, which would allow for better and cleaner information for the service provider, improving information collection and search performance. This could also alleviate problems associated with cookie-churn and accurately determining unique user counts. More logged in user sessions could of course also lead to other advantages, such as better content and advertisement targeting, as well as better user profiling, including emotional profiling.

In some embodiments, as the online user goes about his or her business invoking services across various applications, the user leaves a trail of documents or items in each interaction session. Similarly, friends of the user, and potentially friends of friends, etc., also leave their footprints related to these documents or items. All of these documents and items in various applications can be considered part of the user's online world. In some embodiments, by leveraging the service APIs of these applications, and an authenticated user session, the system is able to acquire and index this logical connection and create a personal index for the user, which can be used in providing services including search in connection with the user's online world. This would incentivize the user to log in, enabling this information collection, indexing, and high-performing search functionality. In some embodiments, a user can opt to turn the indexing or tracking and information collection process “on” or “off”. In some embodiments, when turned “on”, real-time tracking, information, and indexing can be performed as and after new documents and items are generated in the user's online world.

In some embodiments, various user controls and customizations are provided. For example, in some embodiments, the user can control or limit which applications may be tracked, indexed, and made searchable.

Some embodiments of the invention further provide other specialized services. For example, in some embodiments, a service is provided to combine the public elements of a user's personal index to help the user find other people, topics, etc. related to the user's personality, preferences, interests, etc.

Furthermore, in some embodiments of the invention, a user can utilize services from any of various devices, systems and platforms, such as Web-based, desktop, mobile, etc.

Some embodiments of the invention provide methods and systems for use in what can be viewed in some ways as “watching” over a user's online world. Some embodiments rate user perceptions about a user's online activities or communications, or digital “bytes”, and provide monitoring and feedback services on sentiment regarding elements of the user's online world in areas that the user cares to share with others. These services are valuable to an online user who cares to know, and potentially manage, how the user's online world, or elements thereof, are being affected and perceived in other users' responses to the user's online activities and communications. Furthermore, an online user is incentivized to share information regarding the user's online world, such as by allowing tracking during logged-in, authenticated sessions, or by allowing frequent monitoring. This information can then be used for providing other services, such as search-related services, as well as for a variety of other purposes, such as building a better profile of the user and providing targeted content and advertising to the user or other users about which information is acquired.

Some embodiments of the invention include a recognition that, with the advent of open social platforms, for instance, and the explosion in the willingness and ability of users to express themselves online, there has been a great proliferation in digital bytes emitted by online users. Furthermore, communications such as blogs, articles, reviews, comments, status feeds, chat sessions, etc., can easily and quickly find their way just about anywhere across the Internet. This, however, may in some instances evoke unforeseen reaction and sentiment, which may quickly build, and be troublesome and difficult to mitigate or manage. By monitoring and providing services in connection with this, the service provider may at once provide a valuable service to online users, as well as incentivize the users to share their information with the service provider, which the service provider may then leverage for various purposes, including targeted advertising.

Users have had difficulty managing certain situations, such as when a particular comment by the user generates an intense or extreme reaction from users, which can quickly propagate over many domains. Users have lacked an effective way of being centrally alerted to, and being able to effectively manage, situations when one or more of the user's activities or communications cause a sentiment of concern, such as an emotional sentiment, perception or opinion. This concern may late to sentiment of other users generally across various domains, or among users or user groups of particular importance to the user, or across domains of particular significance to the user, for example. Some embodiments of the invention address these and other needs, and some embodiments are customizable by the user in terms of the types of services provided, the user groups or domains of importance, weighting or relative importance, etc. In addition to alerting and reporting, such as integrated, centralized or comprehensive alerts taking into account various applications and domains, some embodiments provide aggregation, consolidation, and classification or rating of sentiment. For example, some embodiments provide a rating on a sentiment scale, or indicate a rating or level on one or more scales, such as scales of popularity, acceptance, etc.

Some embodiments of the invention include, compliment or provide information that can be used in emotional targeting of online users. Generally, emotional targeting of users can include targeting users with content or advertisements based on a determined or predicted emotional state of the user, or determined likely emotional state of the user. Emotional targeting can include collecting information used to determine or predict an emotional state, such as of a set of standard emotional states, of a user at a particular time or during a particular period of time. Emotional profiles of users can be used in such determinations or predictions. Other profiles may also be utilized, such as psychographic profiles or behavioral profiles. Content or advertisements can then be targeted to users based at least in part on being well-suited to the emotional state of the user. Emotional targeting is described in detail in commonly assigned U.S. patent application Ser. No. 12/723,346 filed on Mar. 12, 2010. Some embodiments of the invention provide for collection and analysis of information that can be used in assessing an emotional state of users, and in improving user profiles, such as emotional profiles, psychographic profiles, behavioral profiles, etc. This information and analysis can be used in emotional targeting, or to enhance emotional targeting.

Some embodiments of the invention include a recognition that an online user may have a need for a service that frequently or continuously “watches” over the user's online world. Some embodiments of the invention provide such a service, from a trusted entity, and some embodiments include aspects that are customizable by the user. In some embodiments, the service provider can ensure trustworthiness, respect for privacy concerns, etc., and can be rewarded with, among other things, information from a logged-in user that can be used for many purposes, including advertisement targeting leading to increased revenue.

Some embodiments of the invention include user registration or opt-in and customized user login functionality. In some embodiments, functionality is then provided by which the user can configure settings, customizing various aspects including rating weightings, user groups of particular importance, privacy settings, tracked or untracked applications, etc. Alerting, reporting, and management services can then be provided, such as, for example, deletion or disabling of messaging or other activities that may have invoked or be invoking an undesirable sentiment among users.

In some embodiments, a service monitors and assesses sentiment reflected in comments, blog entries, articles, reviews, recommendations, etc. in response to the user's digital activity and bytes. In some embodiments, desktop applications and activities are also monitored, although, in some embodiments, desktop applications, activities or documents may be kept private.

In some embodiments, a user can set protection configurations that apply thresholds or conditions which, when met, cause the pertinent digital bytes of the user, such as a message that caused a negative sentiment in reaction, to be at least temporarily pulled down, disabled, or deleted, for example, until the user can be reached to provide input or instruction. In some embodiments, feedback can be delivered to the user on-demand, such as via immediate alerts or periodic scores that may, for example, measure sentiment over a fixed time period as aggregated over the responses over that time. The scores could be configured by the user to extend over the entire web, over specific social graphs, over a private network of friends or family, etc. In addition, standardized versions of the score metric could be personalized by the user, such as to weight certain types of domains, content, etc. heavier than others.

Furthermore, some embodiments allow, or are used to help facilitate allowing, a user to “watch” over the online activities and communications of another user. For instance, in some embodiments, a parent, guardian, or care-giver may utilize methods according to embodiments of the invention in watching over the activities and communications of, say, a child or young person. The child's activities, and reactions of other users thereto, can be monitored, and reporting or alerting can be provided to the parent, for example, or blocking of certain activities or communications of the child can be provided, for example.

In some embodiments, the sentiment signals can be processed to deliver social ratings as feedback to a user, which would incentivize the user to trust the service provider by opting-in and sharing more and more of their online world. The ratings could be in the form of an acceptance rating, a popularity rating, or another type of rating.

In some embodiments, to leverage this information, the signals can be tied to an emotional targeting system at the back-end where the user's emotional profiles can, for example, respond to their current perception in the world, and how they react to this emotionally. Classification models can be used to estimate the receptiveness and sensitivity of users to certain brand emotional advertisements, for example, at a particular time.

Some embodiments provide instrumentation to measure the level (such as volume, intensity, depth, and quality of responder) and type of sentiment associated with the particular user's online profile. Based on this, a rating level could be assigned. Management services could rely on this basic set of information to determine conditions for, for example, alerting the user, taking preemptive steps in rolling back certain user activity from the Web forums, cleaning out the spread of its mention in other domains, and generating reports for the user to track trends over time when things are moving towards improved or worsening sentiment.

In some embodiments, “watching” services are complementary to search or other services, and can be performed in parallel to indexing. All documents processed for the sentiment signal can be captured and stored in the user store. Emotional targeting labels could also be applied to the classified documents to aid in watching the perception of the user by elements of their world. Based on applied configurations and the classified documents, the ratings could be evaluated for the current period. Period-over-period and long term trends, in addition to point-in-time conditions, could be evaluated, and alerts could be generated if needed.

In some embodiments, at the back-end, the system can maintain an emotional profile of users that would gain an additional signal for its refinement from the configurations of the user and the current level of user ratings, and apply these in interpreting the most likely state or states of the user's emotion. These would help in user targeting, as well as potentially many other functions, such as functions for the user, an advertising marketplace provider, or other entities associated with an advertising marketplace, such as an online advertising auction-based marketplace. For example, information gained could be used in optimizing or refining matching of advertisements to serving opportunities, advertiser bid adjustment, pricing for advertisement properties or serving opportunities, advertisement selection, advertisement serving, etc.

While the invention is described with reference to the above drawings, the drawings are intended to be illustrative, and the invention contemplates other embodiments within the spirit of the invention.

1. A method comprising:
using one or more computers, monitoring and storing a first set of information relating to Web-based activities of a plurality of users in reaction to Web-based activities of a user;
using one or more computers, based at least in part on the first set of information, performing an assessment of sentiment expressed in reaction to one or more of the Web-based activities of the user;
using one or more computers, storing a second set of information relating to the assessment; and
using one or more computers, based at least in part on the second set of information, providing the user with information relating to the assessment, wherein the information at least provides the user with an indication of the assessed sentiment.

2. The method of claim 1, wherein monitoring and storing a first set of information relating to Web-based activities of a plurality of users in reaction to Web-based activities of a user comprises monitoring information relating to Web-based communications comprising communications associated with one or more social networking Web sites or services.

3. The method of claim 1, wherein performing an assessment of sentiment comprises performing an assessment of emotional sentiment or of opinion.

4. The method of claim 1, wherein performing an assessment of sentiment comprises performing an overall assessment relating to the Web-based activities of the plurality of users as a whole.

5. The method of claim 1, wherein storing a second set of information relating to the assessment comprises storing information providing an overall measure of sentiment expressed in association with one or more particular activities of the user.

6. The method of claim 1, comprising providing one or more Web-based services for the user based on the assessment, wherein the one or more Web-based services relate to manipulation or deletion of one or more Web-based communications of the user.

7. The method of claim 1, wherein the monitoring comprises monitoring Web-based communications associated with the user, and wherein the monitoring is facilitated by tracking based at least in part on logged-in sessions of the user.

8. The method of claim 1, wherein the monitoring comprises monitoring activities associated with a plurality of independently operational Web-based applications provided by different independent providers.

9. The method of claim 1, wherein the monitoring comprises monitoring activities associated with a plurality of platforms including at least one mobile platform.

10. The method of claim 1, wherein the assessment is effected by customized weighting parameters based on information obtained from the user, and wherein the assessment comprises a popularity-associated or acceptance-associated rating associated with one or more activities of the user.

11. The method of claim 1, comprising alerting the user when a specified threshold of assessed negative sentiment has been met or exceeded.

12. The method of claim 1, comprising storing emotional profiles of users, and comprising using the emotional profiles in performing the assessment.

13. The method of claim 1, comprising utilizing monitored information in determining emotional profiles of the user and other users, and comprising utilizing the emotional profiles in targeting particular users with online advertisements based on determined emotional states or determined likely emotional states of the particular users.

14. The method of claim 1, comprising utilizing assessed sentiments of particular users in refining emotional profiles of the particular users.

15. A system comprising:
one or more server computers coupled to a network; and
one or more databases coupled to the one or more server computers;
wherein the one or more server computers are for:
monitoring and storing, in at least one of the one or more databases, a first set of information relating to Web-based activities of a plurality of users in reaction to Web-based activities of a user;
based at least in part on the first set of information, performing an assessment of sentiment expressed in reaction to one or more of the Web-based activities of the user;
storing, in at least one of the one or more databases, a second set of information relating to the assessment; and
based at least in part on the second set of information, providing the user with information relating to the assessment, wherein the information at least provides the user with an indication of the assessed sentiment.

16. The method of claim 15, wherein the one or more server computers are coupled to the Internet.

17. The system of claim 15, wherein performing an assessment of sentiment comprises performing an assessment of emotional sentiment or of opinion.

18. The system of claim 15, wherein storing a second set of information relating to the assessment comprises storing information providing an overall measure of sentiment expressed in association with one or more particular activities of the user.

19. The system of claim 15, wherein the monitoring comprises monitoring activities associated with a plurality of independently operational Web-based applications provided by different independent providers.

20. A computer readable medium or media containing instructions for executing a method comprising:
using one or more computers, monitoring and storing a first set of information relating to Web-based messaging of a plurality of users in reaction to Web-based messaging of a user;
using one or more computers, based at least in part on the first set of information, performing an assessment of emotional sentiment expressed in reaction to one or more instances of the Web-based messaging of the user;
using one or more computers, storing a second set of information relating to the assessment;
using one or more computers, based at least in part on the second set of information, providing the user with feedback information relating to the assessment, wherein the feedback information at least provides the user with an indication of the assessed emotional sentiment; and
using one or more computers, targeting a particular user with an online advertisement based at least in part on a determined emotional state or a determined likely emotional state of the particular user, wherein the determined emotional state or determined likely emotional state of the particular user is determined based at least in part on information of the first set of information relating to Web-based messaging of the particular user.

21. A method comprising:
using one or more computers, monitoring and storing a first set of information relating to Web-based activities of a plurality of users in reaction to Web-based activities of a user;
using one or more computers, based at least in part on the first set of information, performing an assessment of sentiment expressed in reaction to one or more of the Web-based activities of the user;
using one or more computers, storing a second set of information relating to the assessment; and
using one or more computers, based at least in part on the second set of information, providing a second user, other than the user, with information relating to the assessment, wherein the information at least provides the second user with an indication of the assessed sentiment.

22. The method of claim 21, comprising providing a second user, other than the user, with information relating to the assessment, wherein the second user is a parent, guardian or caregiver of the user.
